(19) United States
(12) Patent Application Publication
(10) Pub. No.: US 2018/0114297 A1
(43) Pub. Date: Apr. 26, 2018

(54) SYSTEMS AND METHODS FOR IMAGE NOISE REDUCTION

(71) Applicant: QUALCOMM Incorporated, San Diego, CA (US)

(72) Inventors: Shang-Chih Chuang, New Taipei (TW); Xianbiao Shu, San Diego, CA (US); Xiaoyun Jiang, San Diego, CA (US)

(21) Appl. No.: 15/331,217

(22) Filed: Oct. 21, 2016

(51) Int. Cl. G06T 5/00

(52) U.S. Cl. CPC G06T 5/002; G06T 2207/20182; G06T 2207/10004

(57) ABSTRACT

A method performed by an electronic device is described. The method includes obtaining an image. The method also includes normalizing a set of frequency band amplitudes of the image based on a plurality of normalization gains to produce a normalized set of frequency band amplitudes. The method further includes producing a processed image based on the normalized set of frequency band amplitudes.

### FIELD OF DISCLOSURE

The present disclosure relates generally to electronic devices. More specifically, the present disclosure relates to systems and methods for image noise reduction.

### BACKGROUND

Some electronic devices (e.g., cameras, video camcorders, digital cameras, cellular phones, smart phones, computers, televisions, automobiles, personal cameras, action cameras, surveillance cameras, mounted cameras, connected cameras, robots, drones, smart applications, healthcare equipment, set-top boxes, etc.) capture and/or utilize images. For example, a smartphone may capture and/or process still and/or video images. Processing images may demand a relatively large amount of time, memory, and energy resources. The resources demanded may vary in accordance with the complexity of the processing.

It may be difficult to provide high quality image processing. For example, image capture quality may vary based on a multitude of factors. As can be observed from this discussion, systems and methods that improve image processing may be beneficial.

### SUMMARY

A method performed by an electronic device is described. The method includes obtaining an image. The method also includes normalizing a set of frequency band amplitudes of the image based on a plurality of normalization gains to produce a normalized set of frequency band amplitudes. The method further includes producing a processed image based on the normalized set of frequency band amplitudes. The plurality of normalization gains may include at least two of a radius normalization gain, a skin color normalization gain, a luminance normalization gain, and a chrominance normalization gain. Producing the processed image may include performing an inverse frequency domain transform on amplitude filtered data.

The method may include determining a unified filtering curve based on the plurality of normalization gains. The method may include suppressing image noise based on the plurality of normalization gains, an amplitude suppression gain, and a flatness filtering gain. The method may include performing a frequency domain transform on at least a portion of the image to produce the set of frequency band amplitudes.

The method may include performing skin color detection based on the set of frequency band amplitudes to determine a skin probability. The method may also include determining a skin color normalization gain based on the skin probability. The skin color normalization gain may be one of the plurality of normalization gains.

An electronic device is also described. The electronic device includes a normalizer configured to normalize a set of frequency band amplitudes of an image based on a plurality of normalization gains to produce a normalized set of frequency band amplitudes. The electronic device also includes a noise reducer configured to produce a processed image based on the normalized set of frequency band amplitudes.

A computer-program product is also described. The computer-program product includes a non-transitory computer-readable medium with instructions thereon. The instructions include code for causing an electronic device to obtain an image. The instructions also include code for causing the electronic device to normalize a set of frequency band amplitudes of the image based on a plurality of normalization gains to produce a normalized set of frequency band amplitudes. The instructions further include code for causing the electronic device to produce a processed image based on the normalized set of frequency band amplitudes.

### BRIEF DESCRIPTION OF THE DRAWINGS

FIG. 1 is a block diagram illustrating one example of an electronic device in which systems and methods for image noise reduction may be implemented;

FIG. 2 is a flow diagram illustrating one configuration of a method for image noise reduction;

FIG. 3 is a block diagram illustrating one example of a noise reducer;

FIG. 4 is a graph illustrating one example of tuning by amplitude for noise reduction;

FIG. 5 is a block diagram illustrating a more specific example of a normalizer and a noise reducer;

FIG. 6 is a graph illustrating one example of luminance normalization gain that may be utilized in accordance with some configurations of the systems and methods disclosed herein;

FIG. 7 is a graph illustrating one example of radius normalization gain that may be utilized in accordance with some configurations of the systems and methods disclosed herein;

FIG. 8 is a graph illustrating one example of a YUV color space;

FIG. 9 is a graph illustrating one example of chrominance normalization gain that may be utilized in accordance with some configurations of the systems and methods disclosed herein;

FIG. 10 is a block diagram illustrating an example of a skin color detector and a Gain_{SNR} calculator;

FIG. 11 is a graph illustrating one example of skin color normalization gain that may be utilized in accordance with some configurations of the systems and methods disclosed herein;

FIG. 12 is a graph illustrating one example of amplitude suppression gain that may be utilized in accordance with some configurations of the systems and methods disclosed herein;

FIG. 13 is a diagram illustrating an example of a flatness filtering gain mask kernel that may be utilized in some configurations of the systems and methods disclosed herein;

FIG. 14 is a graph illustrating one example of flatness filtering gain that may be utilized in accordance with some configurations of the systems and methods disclosed herein;

FIG. 15 is a flow diagram illustrating a more specific configuration of a method for image noise reduction; and

FIG. 16 illustrates certain components that may be included within an electronic device configured to implement various configurations of the systems and methods disclosed herein.

### DETAILED DESCRIPTION

Some configurations of the systems and methods disclosed herein may relate to image enhancement. For example, some configurations of the systems and methods disclosed herein may relate to adaptive frequency domain noise reduction. In some approaches, one or more frequency bands may be adaptively filtered according to one or more pixel properties (e.g., level, radius to image center, chrominance, skin color, and/or flatness, etc.).

When an image is captured, it may include image noise. The image may undergo different types of processing, such as white balance processing, color correction, and/or lens shading correction, for example. Some frequency-domain noise reduction techniques reduce noise by analyzing amplitudes of frequency bands and filtering the amplitudes with a configurable amplitude suppression gain curve. The noise level of each amplitude may be impacted by other image signal processing (ISP) blocks. For example, lens shading correction, white balance gains, and/or color correction, etc., may affect the image noise (e.g., frequency band amplitude, alternating current or alternating component (AC) amplitude, discrete cosine transform (DCT) frequency band amplitude, etc.). It should be noted that a direct current (DC) coefficient may be a zero-frequency coefficient, while an AC coefficient may be a non-zero frequency coefficient. AC coefficients may be referred to as ACs.

Adaptive noise reduction may be beneficial in an ISP pipeline. For example, the sensor noise level may not be constant at different brightness, and may affected by one or more ISP blocks, such as white balance gains, color correction matrix, gamma correction, and/or lens shading correction. To handle these non-constant noises, some configurations of the systems and methods disclosed herein may provide adaptive frequency-domain noise reduction with flexible controls by level, radius to image center, chrominance, skin color, amplitude, and/or flatness. In addition to frequency-domain noise reduction, the systems and methods disclosed herein may be extended to spatial noise reduction. Some configurations of the adaptive frequency-domain noise reduction disclosed herein may provide effective noise reduction at a desired level from region to region and from image to image, without significant (e.g., noticeable) impact to edges and/or textures.

In order to suppress the image noise while avoiding impacting textures and/or details in an image, noise reduction strength (e.g., AC amplitude filtering) may be adjusted by these factors. One potential problem may be that it is very challenging to tune many amplitude filtering curves, each of which corresponds to one factor.

Accordingly, the systems and methods disclosed herein may provide a flexible and/or adaptive control framework to achieve noise reduction at a desired and/or effective level. This may be achieved without tuning lots of amplitude suppression gain curves according to different factors such as level, radius, chrominance, skin color, amplitude, and/or flatness in some configurations. To reduce and/or remove the impacts of these factors, several tuning scaling factors may be calculated to normalize frequency band amplitudes. The amplitudes may then be suppressed via a unified filtering curve (e.g., unified amplitude suppression gain curve) in some configurations.

Some benefits of the systems and methods disclosed herein may include one or more of the following. In some approaches to normalization, a unified filtering curve may be tuned to determine the noise reduction strength. This may avoid tuning lots of curves with different impact factors that may lead to a heavy tuning burden. Some approaches to normalization may provide a more flexible way to tune images according to users' preference (e.g., tuning by level, radius, chroma, skin, etc.). One or more (e.g., all) tuning parameters may be controlled (e.g., set, adjustable, etc.) with a tuning graphical user interface (GUI). It should be noted that a similar approach may be applied to spatial domain noise reduction algorithms by normalizing a threshold according to different factors.

Various configurations are now described with reference to the Figures, where like reference numbers may indicate functionally similar elements. The systems and methods as generally described and illustrated in the Figures herein could be arranged and designed in a wide variety of different configurations. Thus, the following more detailed description of several configurations, as represented in the Figures, is not intended to limit scope, as claimed, but is merely representative of the systems and methods.

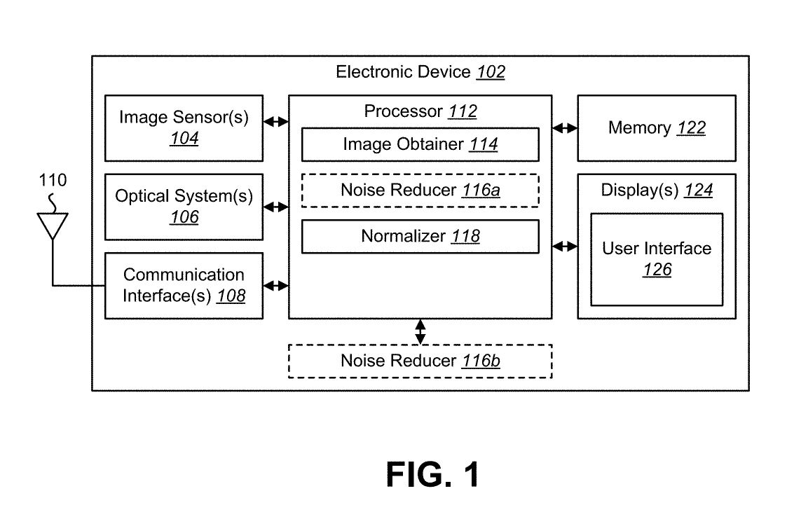

FIG. 1 is a block diagram illustrating one example of an electronic device 102 in which systems and methods for image noise reduction may be implemented. Examples of the electronic device 102 include cameras, video camcorders, digital cameras, cellular phones, smart phones, computers (e.g., desktop computers, laptop computers, etc.), tablet devices, media players, televisions, vehicles, automobiles, personal cameras, wearable cameras, virtual reality devices (e.g., headsets), augmented reality devices (e.g., headsets), mixed reality devices (e.g., headsets), action cameras, surveillance cameras, mounted cameras, connected cameras, robots, aircraft, drones, unmanned aerial vehicles (UAVs), smart appliances, healthcare equipment, gaming consoles, personal digital assistants (PDAs), set-top boxes, appliances, etc. The electronic device 102 may include one or more components or elements. One or more of the components or elements may be implemented in hardware (e.g., circuitry) or a combination of hardware and software and/or firmware (e.g., a processor with instructions).

In some configurations, the electronic device 102 may perform one or more of the functions, procedures, methods, steps, etc., described in connection with one or more of FIGS. 1-16. Additionally or alternatively, the electronic device 102 may include one or more of the structures described in connection with one or more of FIGS. 1-16.

In some configurations, the electronic device 102 may include one or more processors 112, a memory 122, one or more displays 124, one or more image sensors 104, one or more optical systems 106, and/or one or more communication interfaces 108. The processor 112 may be coupled to (e.g., in electronic communication with) the memory 122, display 124, image sensor(s) 104, optical system(s) 106, and/or communication interface(s) 108. It should be noted that one or more of the elements of the electronic device 102 described in connection with FIG. 1 (e.g., image sensor(s) 104, optical system(s) 106, communication interface(s) 108, display(s) 124, etc.) may be optional and/or may not be included (e.g., implemented) in the electronic device 102 in some configurations.

The processor 112 may be a general-purpose single- or multi-chip microprocessor (e.g., an ARM), a special-purpose microprocessor (e.g., a digital signal processor (DSP), an image signal processor (ISP)), a microcontroller, a programmable gate array, dedicated hardware, etc. The processor 112 may be referred to as a central processing unit (CPU) in some configurations. Although just a single processor 112 is shown in the electronic device 102, in an alternative configuration, a combination of processors (e.g., an image signal processor (ISP) and an application processor, an Advanced Reduced Instruction Set Computing (RISC) machine (ARM) and a digital signal processor (DSP), etc.) could be used. The processor 112 may be configured to implement one or more of the methods disclosed herein. The processor 112 may include and/or implement an image obtainer 114, a noise reducer 116a, and/or a normalizer 118 in some configurations.

It should be noted that in some configurations, the noise reducer 116b may not be included in and/or implemented by the processor 112. For example, the noise reducer 116b may be implemented separately (e.g., in a separate chip, separate circuitry, etc.) from the processor 112. Additionally or alternatively, it should be noted that in some configurations, the normalizer 118 may not be included in and/or implemented by the processor 112. For example, the normalizer 118 may be implemented separately (e.g., in a separate chip, separate circuitry, etc.) from the processor 112. When implemented separately, the noise reducer 116b and/or the normalizer 118 may be in electronic communication with the processor 112, the memory 122, with each other, and/or with one or more other elements. In some configurations, the normalizer 118 may be included in the noise reducer 116. When a generic numeric label (e.g., 116 instead of 116a or 116b) is used, this may be meant to refer to the element being implemented on the processor 112, separate from the processor 112, or a combination where corresponding functionality is implemented between both the processor 112 and a separate element. It should be noted that one or more other elements (e.g., the image obtainer 114) may additionally or alternatively be implemented separately from the processor 112 in some configurations.

The memory 122 may be any electronic component capable of storing electronic information. For example, the memory 122 may be implemented as random access memory (RAM), read-only memory (ROM), magnetic disk storage media, optical storage media, flash memory devices in RAM, on-board memory included with the processor, EPROM memory, EEPROM memory, registers, and so forth, including combinations thereof.

The memory 122 may store instructions and/or data. The processor 112 may access (e.g., read from and/or write to) the memory 122. The instructions may be executable by the processor 112 to implement one or more of the methods described herein. Executing the instructions may involve the use of the data that is stored in the memory 122. When the processor 112 executes the instructions, various portions of the instructions may be loaded onto the processor 112 and/or various pieces of data may be loaded onto the processor 112. Examples of instructions and/or data that may be stored by the memory 122 may include image data, image obtainer 114 instructions, noise reducer 116 instructions, and/or normalizer 118 instructions, etc.

The communication interface(s) 108 may enable the electronic device 102 to communicate with one or more other electronic devices. For example, the communication interface(s) 108 may provide one or more interfaces for wired and/or wireless communications. In some configurations, the communication interface(s) 108 may be coupled to one or more antennas 110 for transmitting and/or receiving radio frequency (RF) signals. Additionally or alternatively, the communication interface 108 may enable one or more kinds of wireline (e.g., Universal Serial Bus (USB), Ethernet, etc.) communication.

In some configurations, multiple communication interfaces 108 may be implemented and/or utilized. For example, one communication interface 108 may be a cellular (e.g., 3G, Long Term Evolution (LTE), CDMA, etc.) communication interface 108, another communication interface 108 may be an Ethernet interface, another communication interface 108 may be a universal serial bus (USB) interface, and yet another communication interface 108 may be a wireless local area network (WLAN) interface (e.g., Institute of Electrical and Electronics Engineers (IEEE) 802.11 interface). In some configurations, the communication interface 108 may send information (e.g., image information, image noise reduction information, etc.) to and/or receive information from another device (e.g., a vehicle, a smart phone, a camera, a display, a remote server, etc.).

The electronic device 102 (e.g., image obtainer 114) may obtain one or more images (e.g., digital images, image frames, frames, video, etc.). For example, the electronic device 102 may include the image sensor(s) 104 and the optical system(s) 106 (e.g., lenses) that focus images of scene(s) and/or object(s) that are located within the field of view of the optical system 106 onto the image sensor 104. The optical system(s) 106 may be coupled to and/or controlled by the processor 112 in some configurations. A camera (e.g., a visual spectrum camera or otherwise) may include at least one image sensor and at least one optical system. Accordingly, the electronic device 102 may be one or more cameras and/or may include one or more cameras in some implementations. In some configurations, the image sensor(s) 104 may capture the one or more images (e.g., image frames, video, still images, burst mode images, stereoscopic images, etc.).

Additionally or alternatively, the electronic device 102 may request and/or receive the one or more images from another device (e.g., one or more external cameras coupled to the electronic device 102, a network server, traffic camera(s), drop camera(s), vehicle camera(s), web camera(s), etc.). In some configurations, the electronic device 102 may request and/or receive the one or more images via the communication interface 108. For example, the electronic device 102 may or may not include camera(s) (e.g., image sensor(s) 104 and/or optical system(s) 106) and may receive images from one or more remote device(s) (e.g., one or more networked devices, one or more removable memory devices, etc.). One or more of the images (e.g., image frames) may include one or more scene(s) and/or one or more object(s).

In some configurations, the electronic device 102 may include an image data buffer (not shown). The image data buffer may be included in the memory 122 in some configurations. The image data buffer may buffer (e.g., store) image data from the image sensor(s) 104 and/or external camera(s). The buffered image data may be provided to the processor 112. In some configurations, the same image buffer or a different buffer (e.g., an output image buffer, frame buffer, etc.) may store processed image data.

The display(s) 124 may be integrated into the electronic device 102 and/or may be coupled to the electronic device 102. Examples of the display(s) 124 include liquid crystal display (LCD) screens, light emitting display (LED) screens, organic light emitting display (OLED) screens, plasma screens, cathode ray tube (CRT) screens, etc. In some implementations, the electronic device 102 may be a smartphone with an integrated display. In another example, the electronic device 102 may be coupled to one or more remote displays 124 and/or to one or more remote devices that include one or more displays 124.

In some configurations, the electronic device 102 may include a camera software application. When the camera application is running, images of objects that are located within the field of view of the optical system(s) 106 may be captured by the image sensor(s) 104. The images that are being captured by the image sensor(s) 104 may be presented on the display 124. For example, one or more images may be sent to the display(s) 124 for viewing by a user. In some configurations, these images may be played back from the memory 122, which may include image data of an earlier captured scene. The one or more images obtained by the electronic device 102 may be one or more video frames and/or one or more still images. In some configurations, the display(s) 124 may present one or more enhanced images (e.g., noise-reduced images, etc.) resulting from one or more of the operations described herein.

In some configurations, the electronic device 102 may present a user interface 126 on the display 124. For example, the user interface 126 may enable a user to interact with the electronic device 102. In some configurations, the user interface 126 may enable a user to input a command. For example, the user interface 126 may receive a touch, a mouse click, a gesture, and/or some other indication that indicates a command to reduce image noise and/or one or more image noise reduction settings (e.g., settings and/or tuning for level, radius, chrominance, and/or skin color, etc.). In some configurations, the display 124 may be a touch display (e.g., a touchscreen display). For example, a touch display may detect the location of a touch input. The touch input may indicate the command to reduce image noise (e.g., enhance an image) and/or may indicate one or more image noise reduction settings. It should be noted that some configurations of the systems and methods disclosed herein may be performed automatically, without receiving user input.

The electronic device 102 (e.g., processor 112) may optionally be coupled to, be part of (e.g., be integrated into), include and/or implement one or more kinds of devices. For example, the electronic device 102 may be implemented in a drone or a vehicle equipped with cameras. In another example, the electronic device 102 (e.g., processor 112) may be implemented in an action camera.

The processor 112 may include and/or implement an image obtainer 114. One or more images (e.g., image frames, video, burst shots, etc.) may be provided to the image obtainer 114. For example, the image obtainer 114 may obtain image frames from one or more image sensors 104. For instance, the image obtainer 114 may receive image data from one or more image sensors 104 and/or from one or more external cameras. As described above, the image(s) may be captured from the image sensor(s) 104 included in the electronic device 102 or may be captured from one or more remote camera(s).

In some configurations, the image obtainer 114 may request and/or receive one or more images (e.g., image frames, etc.). For example, the image obtainer 114 may request and/or receive one or more images from a remote device (e.g., external camera(s), remote server, remote electronic device, etc.) via the communication interface 108. The images obtained from the cameras may be enhanced (e.g., noise-reduced) by the electronic device 102 in some configurations.

The processor 112 may include and/or implement a normalizer 118. Alternatively, the normalizer 118 may be implemented separately from the processor 112. For example, the normalizer 118 may be implemented in a chip separate from the processor 112 (e.g., in separate hardware). In some configurations, the normalizer 118 may be included in the noise reducer 116. The normalizer 118 may normalize data based on the image (e.g., a block of image data, one or more frequency band amplitudes from the image, etc.) based on a plurality of normalization gains. For example, the normalizer 118 may normalize a set of frequency band amplitudes of the image to produce a normalized set of frequency band amplitudes. The plurality of normalization gains may include two or more of a radius normalization gain, a skin color normalization gain, a luminance normalization gain, and/or a chrominance normalization gain.

In some configurations, the normalizer 118 may obtain and/or determine one or more of the plurality of normalization gains. For example, the normalizer 118 may determine a luminance normalization gain based on a DC coefficient and/or a level value. Additionally or alternatively, the normalizer 118 may utilize a distance (e.g., radius value) from an image center to determine a radius normalization gain. Additionally or alternatively, the normalizer 118 may utilize coordinate(s) (e.g., one or more color space components) to determine a chrominance normalization gain. Additionally or alternatively, the normalizer 118 may perform skin color detection based on the image (e.g., image block and/or set of frequency band amplitudes, etc.) to determine a skin probability. The normalizer 118 may determine a skin color normalization gain based on the skin probability. Additionally or alternatively, the normalizer 118 may determine an amplitude suppression gain and/or a flatness filtering gain. For example, the normalizer 118 may determine an amplitude suppression gain based on a normalized frequency band amplitude (e.g. AC_{Norm}) value. Additionally or alternatively, the normalizer 118 may determine a flatness filtering gain based on a flatness value. In some configurations, one or more of the gains (e.g., radius normalization gain, skin color normalization gain, luminance normalization gain, chrominance normalization gain, amplitude suppression gain, and/or flatness filtering gain) may be determined based on one or more look-up tables.

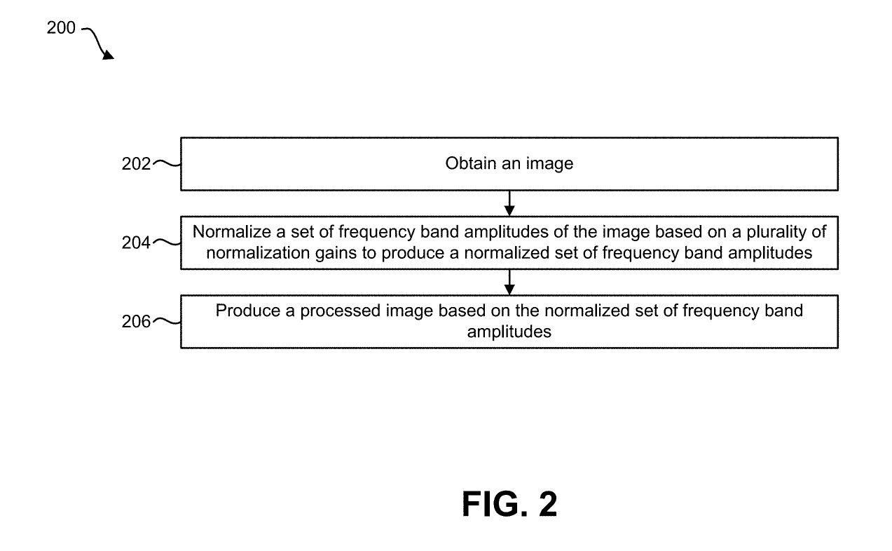

In some configurations, the normalizer 118 may determine a unified filtering curve (e.g., a unified amplitude suppression gain curve) based on the plurality (e.g., set) of normalization gains. More detail on normalizing is described in connection with one or more of FIGS. 2-15.

The processor 112 may include and/or implement a noise reducer 116a in some configurations. Additionally or alternatively, the noise reducer 116b may be implemented separately from the processor 112. For example, the noise reducer 116b may be implemented in a chip separate from the processor 112. The noise reducer 116 may reduce (e.g., reduce and/or remove) image noise in one or more images. In some configurations, reducing the image noise may be based on the normalized set of frequency band amplitudes. Additionally or alternatively, reducing the image noise may be based on a unified filtering curve. Additionally or alternatively, the noise reducer 116 may reduce (e.g., suppress) image noise based on a plurality (e.g., set) of normalization gains, an amplitude suppression gain, and/or a flatness filtering gain.

In some configurations, the noise reducer 116 may perform frequency-domain noise reduction. For example, the noise reducer 116 may convert an image into the frequency domain (using discrete cosine transform (DCT), discrete Fourier transform (DFT), fast Fourier transform (FFT), wavelet transform, block matching and 3D filtering (BM3D), etc., for example). This may produce a set of frequency band amplitudes (e.g., coefficients, DCT coefficients, etc.). The set of frequency band amplitudes may be provided to the normalizer 118. As described above, the normalizer 118 may determine a normalized set of frequency band amplitudes and/or a unified filtering curve.

The noise reducer 116 may perform amplitude filtering on the image. In some configurations, the amplitude filtering may be based on the normalized set of frequency band amplitudes and/or the unified filtering curve. Additionally or alternatively, the amplitude filtering may include thresholding the frequency-domain image (e.g., coefficients) based on amplitude. For instance, amplitudes within one or more ranges (e.g., below a first threshold, between a first and second threshold, etc.) may be regarded as noise (e.g., random noise or weak noise) and may be removed. Amplitudes within one or more ranges (e.g., above a top threshold) may be regarded as an edge or texture. The edges or textures may be preserved and/or enhanced. In some approaches, amplitudes within a range may be regarded as possibly strong noise or weak textures. In some approaches, these amplitudes may be removed. In other approaches, these amplitudes may be preserved. In other approaches, these amplitudes may be preserved at a level (e.g., reduced but preserved). Amplitude filtering the set of frequency band amplitudes may produce amplitude filtered data. In some configurations, the noise reducer 116 may perform an inverse frequency domain transform on the amplitude filtered data. Reducing noise from an image (e.g., input image) may produce a processed image (e.g., a noise-reduced image or a noise-removed image).

In some configurations, the noise reducer 116 may perform spatial domain noise reduction. More details regarding some approaches for noise reduction are given in connection with one or more of FIGS. 2-15.

It should be noted that one or more of the elements or components of the electronic device 102 may be combined and/or divided. For example, one or more of the image obtainer 114, the noise reducer 116, and/or the normalizer 118 may be combined. Additionally or alternatively, one or more of the image obtainer 114, the noise reducer 116, and/or the normalizer 118 may be divided into elements or components that perform a subset of the operations thereof.

FIG. 2 is a flow diagram illustrating one configuration of a method 200 for image noise reduction. The method 200 may be performed by an electronic device (e.g., the electronic device 102 described in connection with FIG. 1).

The electronic device 102 may obtain 202 an image (e.g., input image). This may be accomplished as described in connection with FIG. 1. For example, the electronic device 102 may capture one or more images and/or may receive one or more images from one or more remote devices and/or from removable memory.

The electronic device 102 may normalize 204 a set of frequency band amplitudes of the image based on a plurality of normalization gains to produce a normalized set of frequency band amplitudes. This may be accomplished as described in connection with one or more of FIGS. 1 and 5-15. In some configurations, the electronic device 102 may transform at least a portion of an image (e.g., a block of pixels) into the frequency domain to produce a set of frequency band amplitudes. The electronic device 102 may utilize a plurality of normalization gains (e.g., radius normalization gain, skin color normalization gain, luminance normalization gain, and/or chrominance normalization gain) to normalize the set of frequency band amplitudes.

The electronic device 102 may produce 206 a processed image based on the normalized set of frequency band amplitudes. This may be accomplished as described in connection with one or more of FIGS. 1, 3-5, and 15. For example, the electronic device 102 may amplitude filter the set of frequency band amplitudes based on the normalized set of frequency band amplitudes to produce amplitude-filtered data. The electronic device 102 may perform an inverse frequency domain transform on the amplitude-filtered data to produce 206 the processed image.

In some configurations, the electronic device 102 may present the processed image on one or more displays (e.g., display(s) 124). Additionally or alternatively, the electronic device 102 may store the processed image in memory (e.g., memory 122). Additionally or alternatively, the electronic device 102 may send the processed image to one or more remote devices (with one or more communication interfaces 108, for example).

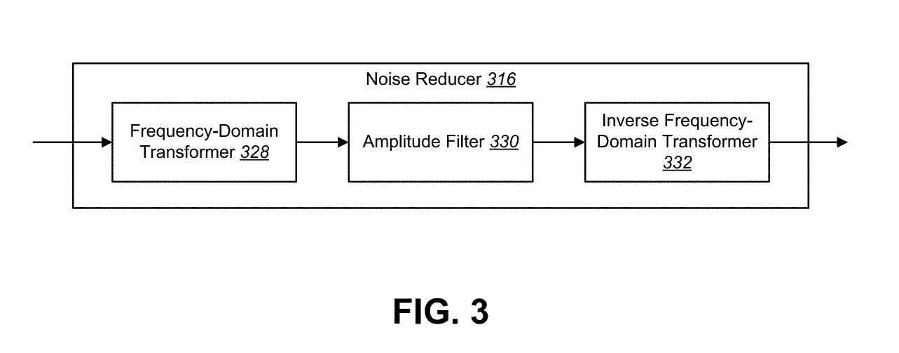

FIG. 3 is a block diagram illustrating one example of a noise reducer 316. The noise reducer 316 may be an example of one or more of the noise reducer 116 described in connection with FIG. 1. The noise reducer 316 may perform frequency-domain noise reduction. The noise reducer 316 may include a frequency-domain transformer 328, an amplitude filter 330, and an inverse frequency-domain transformer 332. The noise reducer 316 may receive an image (e.g., an input image, one or more blocks of pixels, etc.). The image (e.g., one or more N×N pixel blocks) may be provided to the frequency-domain transformer 328.

The frequency-domain transformer 328 may transform the image (e.g., input image) into the frequency domain. For example, the frequency-domain transformer 328 may transform each N×N block (e.g., N×N Y (luma) block) to the frequency domain with a frequency-domain transform such as FFT, DCT, or wavelet transform, etc. For example, frequency-domain noise reduction techniques may represent an image patch (e.g., 8×8 or 16×16) as a matrix of coefficients in the frequency domain (with a DCT, FFT, or Wavelet transform, etc.), where each coefficient (e.g., AC) may represent a unique frequency and may be viewed as a unique repeating texture. In the DCT domain, for instance, each coefficient may represent a combination of vertical and horizontal repeating textures. The coefficient magnitude (e.g., amplitude) may represent the strength of these textures. The resulting frequency band amplitudes (e.g., a DC coefficient and/or one or more AC coefficients) may represent the strength of edges, textures, strong noise, and/or weak noise. The frequency band amplitudes may be provided to the amplitude filter 330.

The amplitude filter 330 may filter the frequency band amplitudes based on amplitude. For example, noise reduction and/or texture preserving may be achieved by scaling up/down the coefficients in the frequency domain. For instance, noise reduction may be performed by suppressing amplitude of one or more frequency bands. If the amplitude of the data is small enough (e.g., less than a threshold), the data may be regarded as noise. The amplitude filter 330 may suppress (e.g., largely suppress) the absolute value of data with a small enough amplitude (that is less than a threshold, for example). If the amplitude of the data is larger (e.g., greater than a threshold), the data may be regarded as strong noise or weak texture. The amplitude filter 330 may preserve (at a certain level, for example) the value of data with an amplitude that is larger (e.g., greater than a threshold). The amplitude-filtered data (e.g., image) may be provided to the inverse frequency-domain transformer 332.

In some configurations, the amplitude filter 330 may perform amplitude filtering based on one or more normalization gains (e.g., a set of normalization gains). For example, the normalization gains may be utilized to determine an amplitude filtering curve, which may be utilized to filter the frequency band amplitudes.

The inverse frequency-domain transformer 332 may transform the amplitude-filtered data (e.g., image) to the spatial domain. For example, the inverse frequency-domain transformer may inversely transform the N×N block to the spatial domain (using inverse FFT (IFFT), inverse DCT (IDCT), inverse wavelet transform, etc., for example). This may produce an N×N block (e.g., N×N Y block) in the spatial domain. For instance, a set of inversely-transformed blocks may result in a processed image.

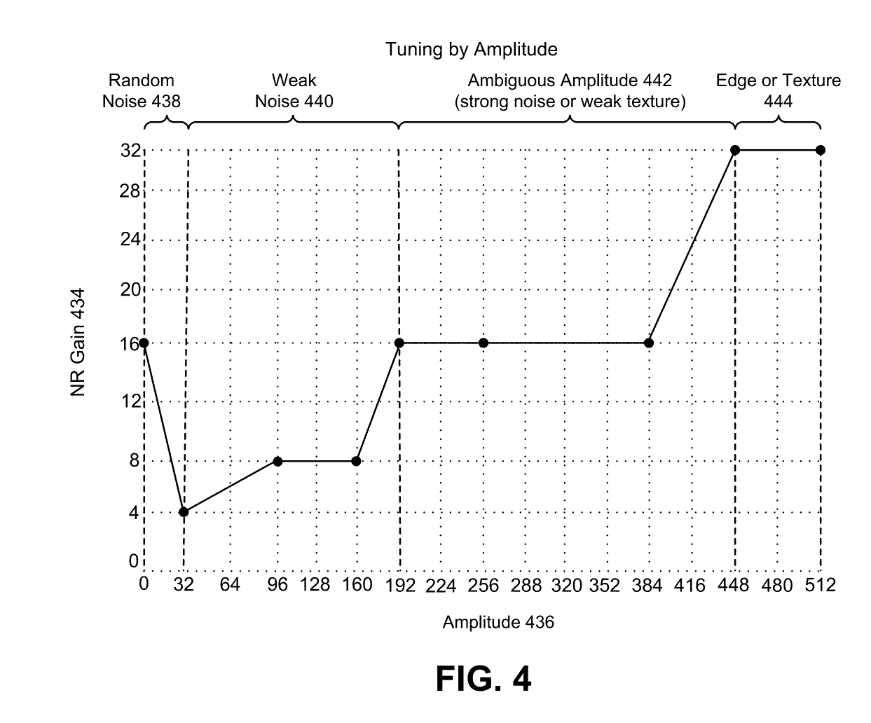

FIG. 4 is a graph illustrating one example of tuning by amplitude for noise reduction. The graph is illustrated in noise reduction (NR) gain 434 corresponding to amplitude 436. In some configurations, one or more of the noise reducers 116, 316 described herein may function with an amplitude filtering curve (e.g., amplitude gain curve, unified filtering curve, a filtering curve based on normalized frequency band amplitudes, etc.). The graph in FIG. 4 illustrates an example of an amplitude filtering curve.

In the DCT domain, each coefficient may present a combination of vertical and horizontal repeating textures (over DCT frequencies, for example). After transforming to the frequency domain, each frequency band amplitude (which may be referred to as AC) may represent the strength of edge or texture 444, weak texture or strong noise 442, weak noise 440, or random noise 438. An amplitude suppression gain curve may be designed to suppress noise according to different amplitudes.

The plot in the graph in FIG. 4 shows an example of an amplitude filtering (e.g., suppression) gain curve (e.g., Gain_{NR}), which may be applied to amplitudes. Amplitude filtering may be carried out in accordance with the filtering curve based on the amplitude 436 of DCT frequencies. Noise reduction may be performed by suppressing one or more amplitudes (e.g., AC coefficients). For example, amplitude filtering may be performed in accordance with the formula AC′=AC×Gain_{NR}, where AC is the frequency band amplitude, Gain_{NR} is the noise reduction gain, and AC′ is the amplitude-filtered data (e.g., filtered frequency band amplitudes).

Noises with small amplitude may be suppressed. For example, if an amplitude is small enough, it may be viewed as noise and its absolute value may be largely suppressed. Edges or textures with large amplitude may be preserved and/or enhanced. As illustrated in FIG. 4, each amplitude region (e.g., random noise 438, weak noise 440, ambiguous amplitude 442, and/or edge or texture 444) may be filtered in accordance with the amplitude filtering curve. For example, if an amplitude is not that small, it may be viewed as strong noise or weak texture and its value may be preserved at certain level (e.g., 50%). Certain details may be damaged, but strong noise may be removed. The amplitude-filtered data (e.g., filtered frequency band amplitudes, N×N block, etc.) may be inversely transformed and/or aggregated to an image frame (e.g., output image).

In some configurations, an amplitude filtering curve may be based on one or more normalization gains (e.g., a set of normalization gains). For example, the normalization gains may be utilized to determine an amplitude filtering curve, which may be utilized to filter the frequency band amplitudes.

Examples of amplitude filtering are given in accordance with Tables (1), (2), and (3), where Table (1) is an example of an edge, Table (2) is an example of texture, and Table (3) is an example of a flat region. Table (1) illustrates an example of preserving a horizontal low frequency edge.

TABLE (1)
Edge
8 × 8 DCT before filtering

| | | | | | | | |
|---|---|---|---|---|---|---|---|
| 5654 | 75 | 35 | 59 | 26 | 36 | 121 | 12 |
| 448 | 67 | 117 | 51 | 46 | 14 | 21 | 1 |
| 199 | 160 | 97 | 38 | 65 | 8 | 25 | 14 |
| 176 | 77 | 32 | 10 | 57 | 10 | 46 | 10 |
| 156 | 120 | 6 | 8 | 56 | 20 | 4 | 0 |
| 149 | 11 | 26 | 28 | 45 | 19 | 0 | 12 |
| 55 | 204 | 71 | 7 | 4 | 76 | 61 | 21 |
| 22 | 24 | 155 | 89 | 66 | 6 | 4 | 4 |

8 × 8 DCT after filtering

| | | | | | | | |
|---|---|---|---|---|---|---|---|
| 5654 | 13 | 3 | 8 | 3 | 3 | 29 | 3 |
| 448 | 11 | 28 | 6 | 6 | 3 | 3 | 0 |
| 95 | 48 | 23 | 3 | 11 | 2 | 3 | 3 |
| 74 | 15 | 3 | 2 | 7 | 2 | 6 | 2 |
| 41 | 29 | 1 | 2 | 7 | 4 | 0 | 0 |
| 35 | 2 | 3 | 3 | 4 | 3 | 0 | 3 |
| 7 | 98 | 12 | 1 | 0 | 15 | 10 | 3 |
| 3 | 3 | 41 | 18 | 11 | 1 | 0 | 0 |

Table (2) illustrates an example of preserving a vertical middle frequency edge.

TABLE (2)
Texture
8 × 8 DCT before filtering

| | | | | | | | |
|---|---|---|---|---|---|---|---|
| 6106 | 44 | 203 | 85 | 280 | 314 | 92 | 17 |
| 63 | 32 | 123 | 10 | 46 | 46 | 86 | 52 |
| 113 | 19 | 17 | 109 | 94 | 49 | 176 | 66 |
| 66 | 36 | 26 | 36 | 36 | 68 | 29 | 40 |
| 114 | 7 | 115 | 22 | 8 | 11 | 55 | 1 |
| 82 | 89 | 17 | 4 | 0 | 3 | 52 | 26 |
| 28 | 26 | 7 | 7 | 25 | 5 | 12 | 25 |
| 24 | 40 | 4 | 15 | 24 | 13 | 1 | 12 |

8 × 8 DCT after filtering

| | | | | | | | |
|---|---|---|---|---|---|---|---|
| 6106 | 5 | 88 | 18 | 280 | 314 | 20 | 3 |
| 9 | 3 | 26 | 2 | 6 | 6 | 18 | 7 |
| 24 | 3 | 3 | 23 | 20 | 6 | 77 | 10 |
| 10 | 3 | 2 | 3 | 3 | 10 | 2 | 4 |
| 24 | 1 | 24 | 3 | 2 | 2 | 7 | 0 |
| 14 | 19 | 3 | 0 | 0 | 0 | 7 | 2 |
| 2 | 2 | 1 | 1 | 2 | 1 | 3 | 2 |
| 2 | 4 | 0 | 3 | 2 | 3 | 0 | 3 |

Table (3) illustrates an example of suppressing all amplitudes.

TABLE (3)
Flat Region
8 × 8 DCT before filtering

| | | | | | | | |
|---|---|---|---|---|---|---|---|
| 7236 | 31 | 57 | 12 | 66 | 62 | 33 | 85 |
| 70 | 83 | 206 | 130 | 8 | 27 | 58 | 12 |
| 113 | 109 | 23 | 45 | 20 | 55 | 46 | 31 |
| 83 | 7 | 72 | 65 | 56 | 32 | 9 | 67 |
| 12 | 70 | 91 | 95 | 134 | 29 | 0 | 2 |
| 88 | 28 | 70 | 0 | 17 | 60 | 21 | 3 |
| 22 | 58 | 76 | 38 | 22 | 4 | 12 | 25 |
| 52 | 7 | 5 | 42 | 31 | 6 | 8 | 15 |

8 × 8 DCT after filtering

| | | | | | | | |
|---|---|---|---|---|---|---|---|
| 7236 | 1 | 5 | 2 | 7 | 7 | 2 | 11 |
| 8 | 11 | 67 | 21 | 1 | 2 | 5 | 2 |
| 18 | 17 | 3 | 3 | 3 | 5 | 4 | 1 |
| 11 | 1 | 8 | 7 | 5 | 2 | 1 | 7 |
| 2 | 8 | 12 | 15 | 21 | 1 | 0 | 0 |
| 12 | 2 | 8 | 0 | 2 | 5 | 2 | 0 |
| 2 | 5 | 10 | 2 | 2 | 0 | 2 | 2 |
| 5 | 1 | 1 | 3 | 1 | 1 | 1 | 2 |

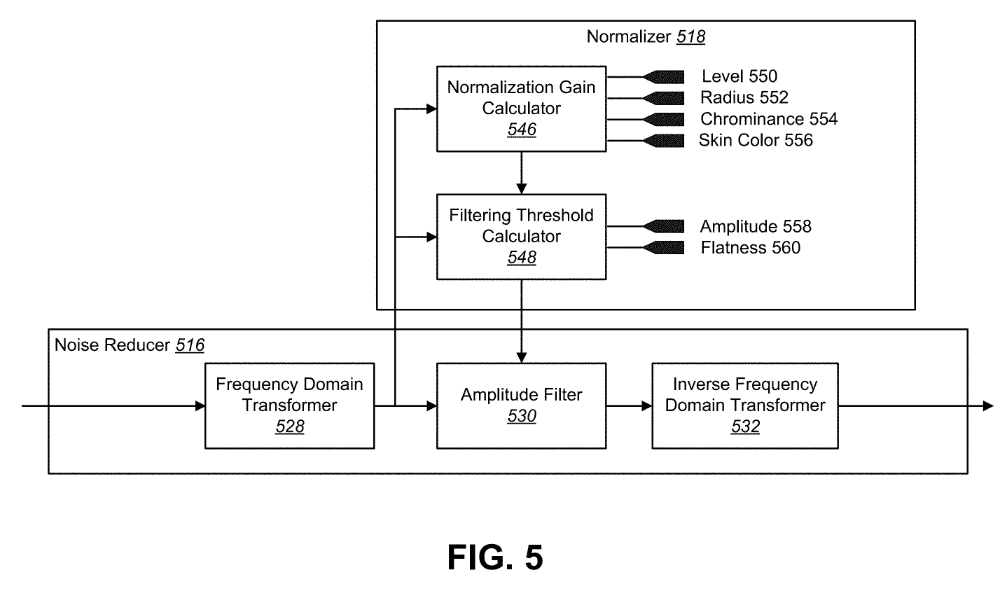

FIG. 5 is a block diagram illustrating a more specific example of a normalizer 518 and a noise reducer 516. The normalizer 518 and/or the noise reducer 516 may be examples of and/or may performed one or more similar functions of corresponding elements described in connection with one or more of FIGS. 1 and 3.

The normalizer 518 may include a normalization gain calculator 546 and a filtering threshold calculator 548. The noise reducer 516 may include a frequency-domain transformer 528, an amplitude filter 530, and an inverse frequency-domain transformer 532. The noise reducer 516 may receive an image (e.g., one or more image blocks, one or more N×N Y blocks of an image, etc.). The image (e.g., one or more N×N pixel blocks) may be provided to the frequency-domain transformer 528.

The frequency-domain transformer 528 may transform the image (e.g., the one or more blocks) into the frequency domain. For example, the frequency-domain transformer 528 may transform each block to the frequency domain with a frequency-domain transform such as FFT, DCT, or wavelet transform, etc. The resulting frequency band amplitudes (e.g., a frequency-domain transformed block), which may be denoted AC, may be provided to the normalizer 518 (e.g., to the normalization gain calculator 546 and/or to the filtering threshold calculator 548) and to the amplitude filter 530. The frequency-domain transformer 528 may determine a zero-frequency coefficient (e.g., DC) in some approaches, which may be provided to one or more of the normalizer 518 (e.g., to the normalization gain calculator 546 and/or to the filtering threshold calculator 548) and the amplitude filter 530.

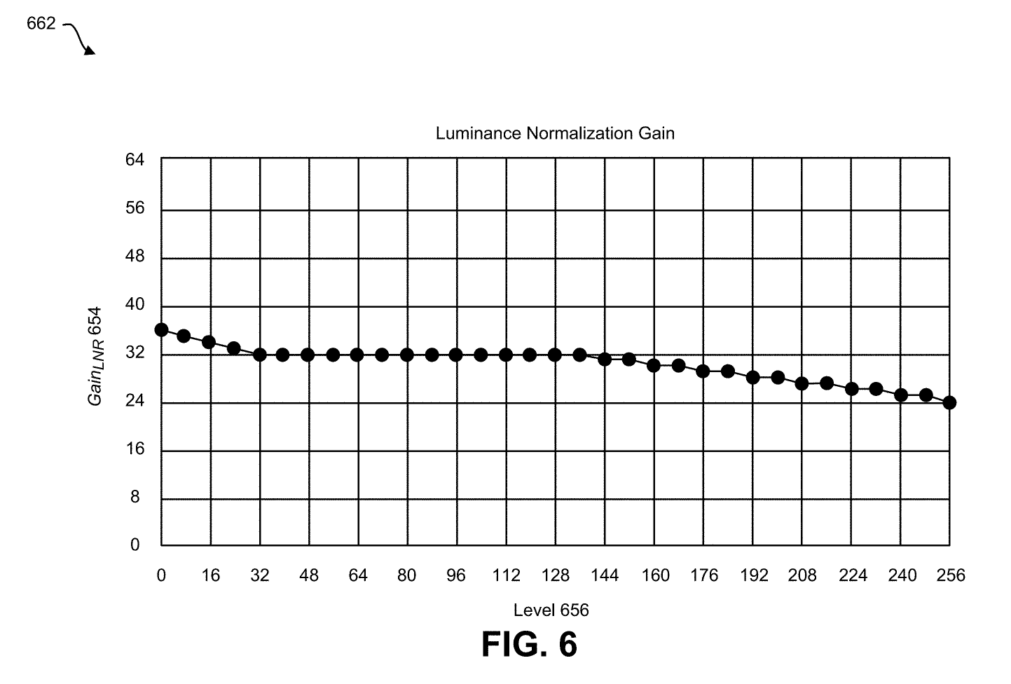

The normalization gain calculator 546 may determine a plurality (e.g., set) of normalization gains (e.g., impact factors for integration into noise reduction). For example, the normalization gain calculator 546 may determine one or more of a luminance normalization gain (Gain_{LNR}), a radius normalization gain (Gain_{RNR}), a chrominance normalization gain (Gain_{CNR}), and/or a skin color normalization gain (Gain_{SNR}). More detail regarding the luminance normalization gain (Gain_{LNR}), radius normalization gain (Gain_{RNR}), chrominance normalization gain (Gain_{CNR}), and/or skin color normalization gain (Gain_{SNR}) is given in connection with one or more of FIGS. 6-11.

In some configurations, the normalization gain calculator 546 may determine one or more of the plurality (e.g., set) of normalization gains based on one or more parameters. For example, the normalization gain calculator 546 may obtain, receive, and/or access a level parameter 550, a radius parameter 552, a chrominance parameter 554, and/or a skin color parameter 556. In some configurations, one or more of the level parameter 550, a radius parameter 552, a chrominance parameter 554, and/or a skin color parameter 556 may be one or more look-up tables (LUTs) for determining respective normalization gains. In some configurations, the level parameter 550, radius parameter 552, chrominance parameter 554, and/or skin color parameter 556 may be obtained from memory and/or a user input (e.g., may be tuned by a user input). For example, a user interface may receive an input that indicates and/or tunes one or more of the parameters 550, 552, 554, 556. Additionally or alternatively, the level parameter 550, radius parameter 552, chrominance parameter 554, and/or skin color parameter 556 may be predetermined. Additionally or alternatively, the level parameter 550, radius parameter 552, chrominance parameter 554, and/or skin color parameter 556 may be determined based on one or more factors (e.g., image data, user setting, etc.).

In some approaches, the luminance normalization gain (Gain_{LNR}), radius normalization gain (Gain_{RNR}), chrominance normalization gain (Gain_{CNR}), and/or skin color normalization gain (Gain_{SNR}) may be determined from (e.g., looked up from) the level parameter 550, radius parameter 552, chrominance parameter 554, and/or skin color parameter 556. Additionally or alternatively, the normalization gain calculator 546 may determine (e.g., control, tune, adjust, etc.) the luminance normalization gain (Gain_{LNR}), radius normalization gain (Gain_{SNR}), chrominance normalization gain (Gain_{CNR}), and/or skin color normalization gain (Gain_{SNR}) based on the level parameter 550, radius parameter 552, chrominance parameter 554, and/or skin color parameter 556.

In some approaches, one or more of the normalization gains (e.g., the luminance normalization gain (Gain_{LNR}), radius normalization gain (Gain_{RNR}), chrominance normalization gain (Gain_{CNR}), and/or skin color normalization gain (Gain_{SNR})) may be calculated with one or more look-up tables (LUTs) based on one or more of the level parameter 550, radius parameter 552, chrominance parameter 554, and/or skin color parameter 556. For example, one or more of the level parameter 550, radius parameter 552, chrominance parameter 554, and/or skin color parameter 556 may be LUTs stored in memory, in registers, etc. One or more of the LUTs may be tuned based on user preference (e.g., user input).

An example of the level parameter 550 is given as the graph illustrated in FIG. 6. For instance, the normalization gain calculator 546 may determine (e.g., look up) a luminance normalization gain (Gain_{LNR}) based on the level parameter 550 with a level value (e.g., the horizontal coordinate or x coordinate illustrated in FIG. 6). In some configurations, the normalization gain calculator 546 may determine the level value based on one or more coefficients (e.g., DC).

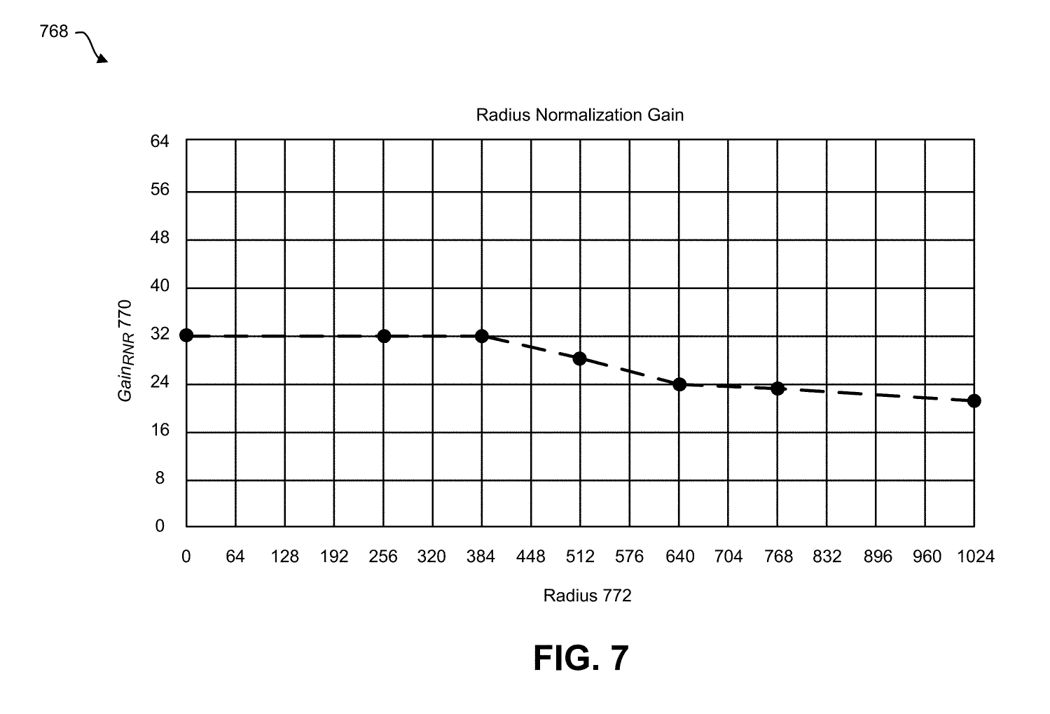

An example of the radius parameter 552 is given as the graph illustrated in FIG. 7. For instance, the normalization gain calculator 546 may determine (e.g., look up) a radius normalization gain (Gain_{RNR}) based on the radius parameter 552 with a radius value (e.g., the horizontal coordinate or x coordinate illustrated in FIG. 6). In some configurations, the radius value may be the radius (of a coefficient or corresponding pixel, for example) to the image center.

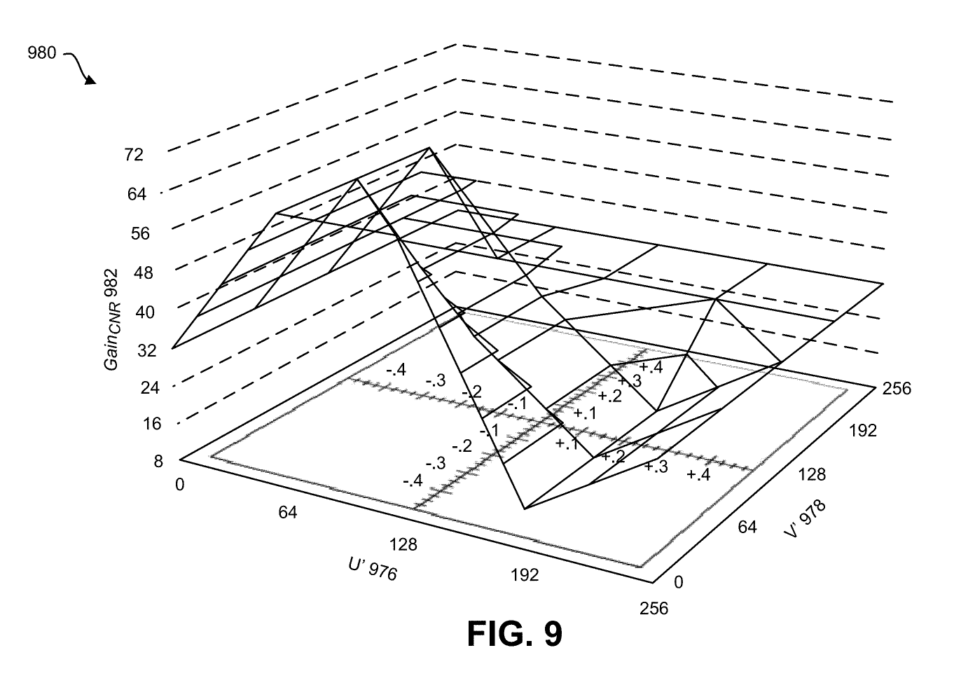

An example of the chrominance parameter 554 is given as the graph illustrated in FIG. 9. For instance, the normalization gain calculator 546 may determine (e.g., look up) a chrominance normalization gain (Gain_{CNR}) based on a chrominance parameter 554 with coordinates (e.g., luminance differences, U′ and V,′ U and V, etc.). For example, the coordinates may be based on the input image (e.g., image block, color space component(s), and/or AC coefficient block, etc.).

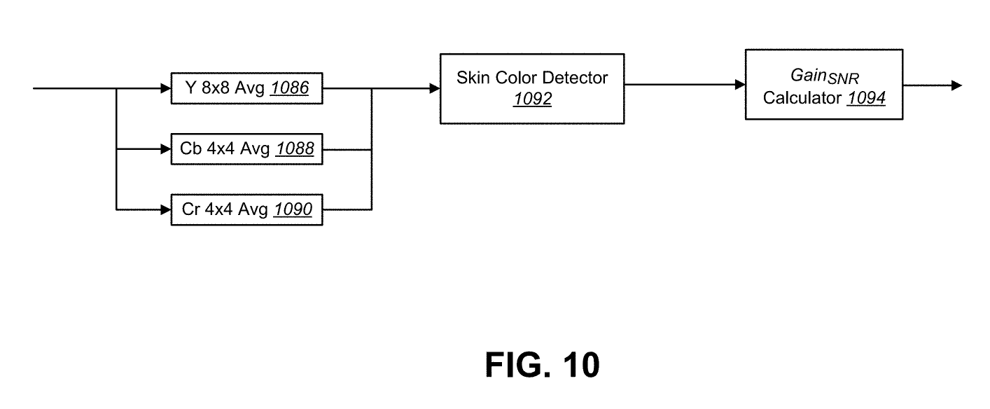

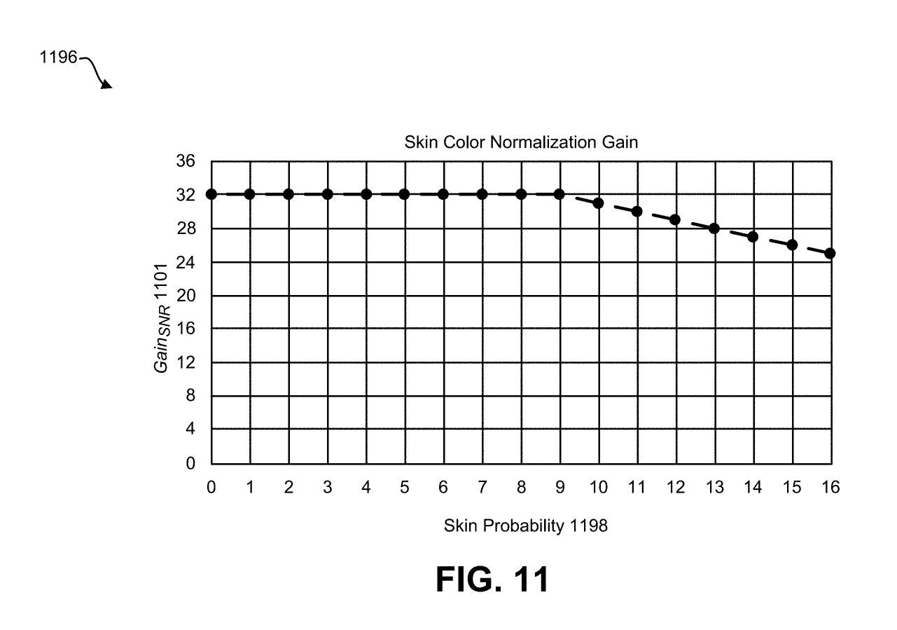

An example of the skin color parameter 556 is given as the graph illustrated in FIG. 11. For instance, the normalization gain calculator 546 may determine (e.g., look up) a skin color normalization gain (Gain_{SNR}) based on the skin color parameter 556 with a skin probability. In some approaches, the skin probability may be determined as described in connection with FIG. 10. For example, the normalization gain calculator 546 may spatially average information in one or more sub-blocks based on an image block (e.g., a block of pixels of an image provided to the noise reducer 516).

In some approaches, the normalization gain calculator 546 may combine (e.g., multiply) the luminance normalization gain (Gain_{LNR}), radius normalization gain (Gain_{RNR}), chrominance normalization gain (Gain_{CNR}) and/or skin color normalization gain (Gain_{SNR}) to produce a combined normalization gain. Accordingly, the combined normalization gain may include two or more (e.g., a combination of) normalization gains (e.g., two or more of Gain_{LNR}, Gain_{RNR}, Gain_{CNR}, and Gain_{SNR}). In some approaches, the combined normalization gain may be denoted Gain_{Norm}. For example, the normalization gain calculator 546 may calculate the combined normalization gain as Gain_{Norm}=Gain_{LNR}×Gain_{RNR}×Gain_{CNR}×Gain_{SNR}. In some approaches, a normalization gain (e.g., combined normalization gain, Gain_{Norm}, one or more of Gain_{LNR}, Gain_{RNR}, Gain_{RNR}, Gain_{SNR}, etc.) may be provided to the filtering threshold calculator 548. The normalization gain may be a curve over a range of frequency bands. The range of frequency bands may correspond to one block (e.g., an image block provided to the noise reducer 516, a block of AC coefficients, etc.).

The filtering threshold calculator 548 may utilize one or more of the normalization gains (e.g., a normalization gain, the combined normalization gain, Gain_{Norm}, one or more of Gain_{LNR}, Gain_{RNR}, Gain_{CNR}, Gain_{SNR}, etc.) to normalize frequency band amplitudes (e.g., ACs). As illustrated in FIG. 5, an input to the filtering threshold calculator 548 may include one or more AC coefficients. In some approaches, the filtering threshold calculator 548 may determine the normalized frequency band amplitude (e.g., AC_{Norm}) for each AC coefficient. For each frequency band amplitude (e.g., DCT AC amplitude), for example, the filtering threshold calculator 548 may calculate the normalized frequency band amplitude (e.g., AC_{Norm}) in accordance with the formula AC_{Norm}=|AC|×Gain_{Norm} or AC_{Norm}=|AC|×Gain_{LNR}×Gain_{RNR}×Gain_{RNR}×Gain_{SNR}. In some approaches, Gain_{LNR}, Gain_{RNR}, Gain_{RNR}, and/or Gain_{RNR} may be normalized to be between [0.0, 1.0]. It should be noted that one or more of the normalization gains may be utilized in this calculation.

In some approaches, the normalized set of frequency band amplitudes may be utilized to obtain a unified filtering curve. In some configurations, the normalized frequency band amplitudes (e.g., a set of AC_{Norm} values) may be utilized by the filtering threshold calculator 548 to determine one or more filtering curves and/or a unified filtering curve. For example, the filtering threshold calculator 548 may determine an amplitude suppression gain (Gain_{NR}) and/or a flatness filtering gain (Gain_{RNR}). The filtering curve(s) may be used to perform noise reduction (e.g., suppress amplitudes) on one or more frequency band amplitudes. For example, a unified Gain_{NR} may be calculated according to AC_{Norm} and may be applied to each AC.

In some configurations, the filtering threshold calculator 548 may determine one or more of the filtering curves based on one or more parameters. For example, the filtering threshold calculator 548 may receive, obtain, and/or access an amplitude parameter 558 and/or a flatness parameter 560. In some configurations, the amplitude parameter 558 and/or flatness parameter 560 may be obtained from memory and/or a user input (e.g., may be tuned by a user input). For example, a user interface may receive an input that indicates and/or tunes one or more of the parameters 558, 560. Additionally or alternatively, the amplitude parameter 558 and/or flatness parameter 560 may be predetermined. Additionally or alternatively, the amplitude parameter 558 and/or flatness parameter 560 may be determined based on one or more factors (e.g., image data, user setting, etc.). In some approaches, the amplitude suppression gain (Gain_{NR}) and/or flatness filtering gain (Gain_{FNR}) may be determined from (e.g., looked up from) the amplitude parameter 558 and/or flatness parameter 560. Additionally or alternatively, the filtering threshold calculator 548 may determine (e.g., control, tune, adjust, etc.) the amplitude suppression gain (Gain_{NR}) and/or flatness filtering gain (Gain_{FNR}) based on the amplitude parameter 558 and/or flatness parameter 560.

In some approaches, one or more of the gains (e.g., the amplitude suppression gain (Gain_{NR}) and/or flatness filtering gain (Gain_{FNR})) may be calculated with one or more look-up tables (LUTs) based on the amplitude parameter 558 and/or flatness parameter 560. For example, one or more of the amplitude parameter 558 and/or flatness parameter 560 may be LUTs stored in memory, in registers, etc.

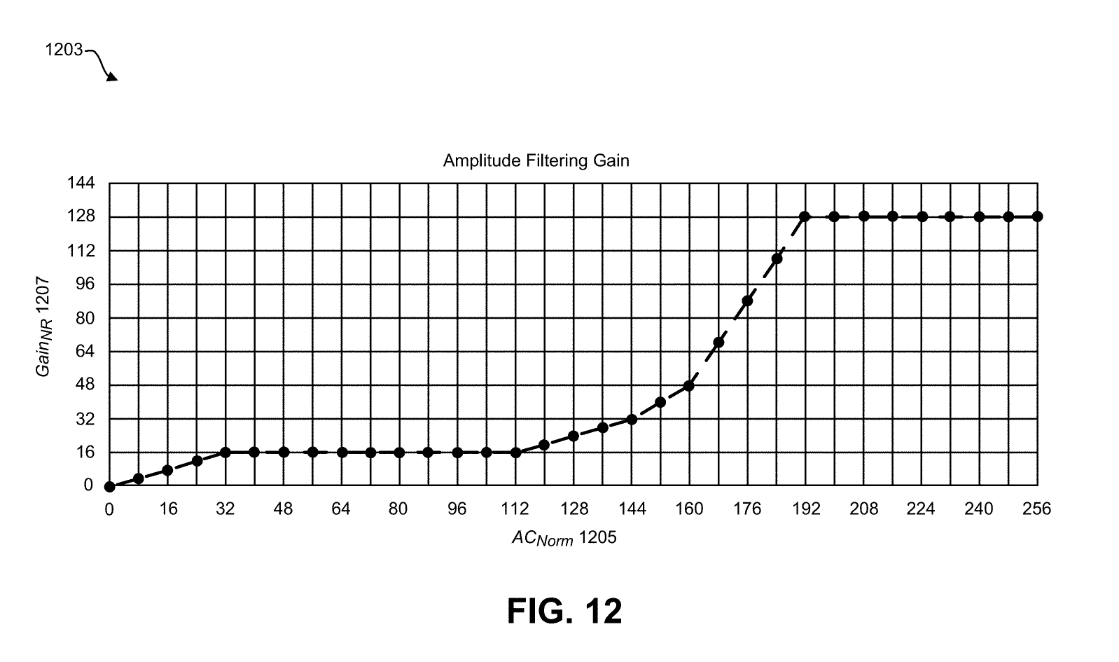

An example of the amplitude parameter 558 is given as the graph illustrated in FIG. 12. For instance, the filtering threshold calculator 548 may determine (e.g., look up) an amplitude suppression gain (Gain_{NR}) (e.g., de-noising gain) based on the amplitude parameter 558 with a normalized frequency band amplitude (e.g., an AC_{Norm} value) (e.g., the horizontal coordinate or x coordinate illustrated in FIG. 12).

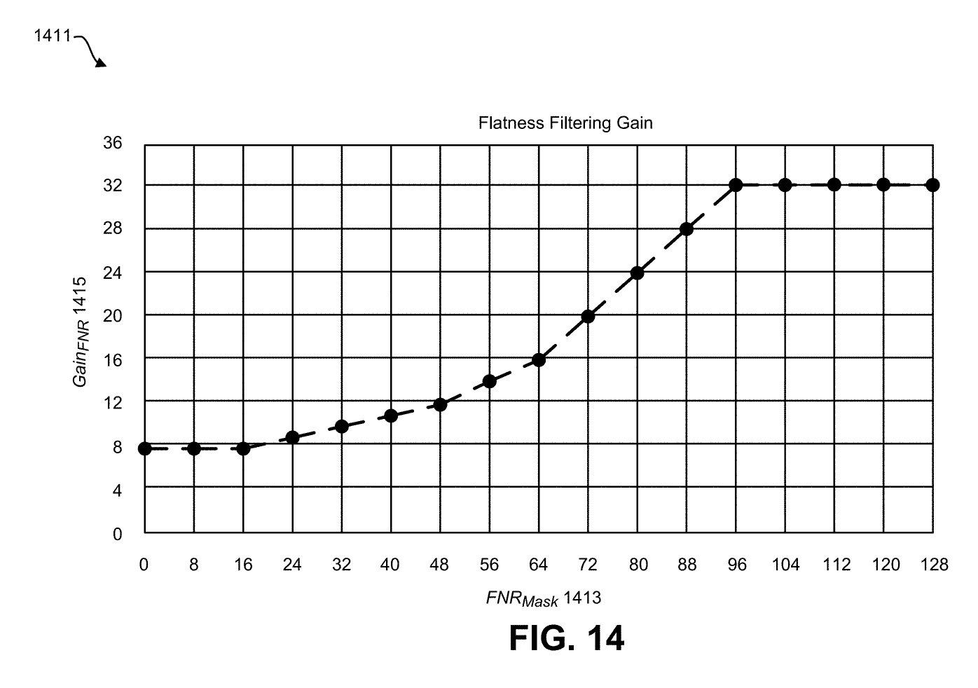

An example of the flatness parameter 560 is given as the graph illustrated in FIG. 14. For instance, the filtering threshold calculator 548 may determine (e.g., look up) a flatness filtering gain (Gain_{FNR}) based on the flatness parameter 560 with a flatness value (e.g., an FNR_{Mask} value) (e.g., the horizontal coordinate or x coordinate illustrated in FIG. 14).

In some configurations, the filtering threshold calculator 548 may determine (e.g., calculate) a unified filtering curve. The unified filtering curve may be determined based on the normalized frequency band amplitudes. In some configurations, the unified filtering curve may be denoted Gain_{NR}(AC_{Norm}) (e.g., Curve_{unified}=Gain_{NR} (AC_{Norm})). The amplitude suppression gain (Gain_{NR}) (e.g., the unified filtering curve) and/or flatness filtering gain (Gain_{FNR}) may be provided to the noise reducer 516 (e.g., to the amplitude filter 530). Alternatively, the unified filtering curve may be calculated in accordance with the formula Curve_{unified}=Gain_{NR} (AC_{Norm})×Gain_{FNR}.

The amplitude filter 530 may filter the frequency band amplitudes based on amplitude. For example, noise reduction may be performed by suppressing amplitude of one or more frequency bands (e.g., DCT AC amplitude). As described herein, one or more factors such as level, radius, chrominance, skin color, amplitude, and/or flatness may be utilized to filter (e.g., suppress) ACs. For example, Gain_{LNR}, Gain_{RNR}, Gain_{CNR}, and/or Gain_{FNR} may be calculated according to one or more factors and/or may be used to normalize ACs to utilize a unified Gain_{NR} and Gain_{FNR}. For instance, two or more normalization gains (e.g., Gain_{LNR}, Gain_{RNR}, Gain_{FNR}, Gain_{SNR}) may be utilized to tune a unified amplitude suppression gain curve (e.g., Gain_{NR}) and a flatness filtering gain (e.g., Gain_{FNR}) to determine the noise reduction strength. FIG. 5 illustrates an example of normalization gain calculation. For instance, normalization as disclosed herein may provide a more flexible way to tune images for users' preferences.

In some configurations, the amplitude filter 530 may filter the frequency band amplitudes based on the plurality (e.g., set) of normalization gains (e.g., the normalized set of frequency band amplitudes), the amplitude suppression gain, and/or the flatness filtering gain. In some configurations, the amplitude filter 530 may filter the set of frequency band amplitudes with the unified filtering curve (e.g., Gain_{NR}) to produce filtered data. For example, the amplitude filter 530 may filter the frequency band amplitudes in accordance with AC′=AC×Gain_{NR} (AC_{Norm})×Gain_{FNR}, AC′=AC×Gain_{NR} (Gain_{LNR}, Gain_{RNR}, Gain_{CNR}, Gain_{SNR})×Gain_{FNR} and/or AC′=AC×Curve_{unified}×Gain_{FNR}. In some approaches, Gain_{NR}(AC_{Norm}) and/or Gain_{FNR} may be normalized to be between [0.0, 1.0]. The amplitude filter 530 may, for each DCT AC amplitude, suppress amplitude by filtering gains, for example. The filtered data (e.g., amplitude-filtered data) may be provided to the inverse frequency-domain transformer 532.

The inverse frequency-domain transformer 532 may transform the filtered data (e.g., amplitude-filtered data) to produce a processed image (in the spatial domain, for instance). For example, the inverse frequency-domain transformer may inversely transform the N×N block to the spatial domain (using inverse FFT (IFFT), inverse DCT (IDCT), inverse wavelet transform, etc., for example). This may produce an N×N block (e.g., N×N Y block) in the spatial domain. For instance, a set of inversely-transformed blocks may result in a processed image.

In accordance with some configurations of the systems and methods disclosed herein, some normalization gains may be calculated to normalize the ACs to unified magnitudes (e.g., luminance normalization gain (Gain_{LNR}), radius normalization gain (Gain_{RNR}), chrominance normalization gain (Gain_{FNR}), and/or skin color normalization gain (Gain_{SNR})). One or more of these gains may be applied to ACs first, which may allow filtering (e.g., suppressing) ACs without the impact of other image processing (e.g., other ISP blocks), for example.

Amplitude filtering (e.g., suppression) gain (Gain_{NR}) and/or flatness filtering gain (Gain_{FNR}) may be calculated to suppress noise. The amplitude filtering gain may be calculated based on the normalized AC. The flatness filtering gain may be calculated based on estimated flatness. Smaller ACs and/or ACs in flat regions may be suppressed.

FIG. 6 is a graph 662 illustrating one example of luminance normalization gain (Gain_{LNR}) that may be utilized in accordance with some configurations of the systems and methods disclosed herein. The graph 662 is illustrated in Gain_{LNR} 654 over level 656. The luminance normalization gain may be utilized to normalize frequency band amplitudes (e.g., ACs). Smaller luminance normalization gain may lead to smaller normalized ACs, which may result in greater suppression of ACs. A piecewise linear curve may be used to calculate Gain_{LNR} 654 for a block as shown in FIG. 6, for example. The frequency band amplitudes may be normalized according to a user's preference (e.g., user setting) in some approaches. In some configurations, the level 656 may be an average of image data. For example, the level 656 may be determined in accordance with the formula

$$level = \frac{DC}{64} ( e . g . , an 8 x 8 average ) ,$$

where DC is a zero-frequency coefficient amplitude.

In some approaches, the level 656 described in connection with FIG. 6 (e.g., a horizontal coordinate or x coordinate) may be an example of the level value described in connection with one or more of FIGS. 1 and 5. For example, the Gain_{LNR} 654 values may be stored (in a LUT, for example) and may be determined (e.g., looked up) with the corresponding level 656 values.

FIG. 7 is a graph 768 illustrating one example of radius normalization gain (Gain_{RNR}) that may be utilized in accordance with some configurations of the systems and methods disclosed herein. The graph 768 is illustrated in Gain_{RNR} 770 over radius 772 to image center (in pixels, for example). The radius normalization gain may be utilized to normalize frequency band amplitudes (e.g., ACs) affected by lens shading compensation. The radius normalization gain curve may be tuned according to shading compensation strength. Smaller radius normalization gain may lead to smaller normalized ACs, which may result in greater suppression of ACs. A piecewise linear curve may be utilized to calculate Gain_{RNR} 770 for a block as shown in FIG. 7, for example.

In some approaches, the radius 772 described in connection with FIG. 7 (e.g., a horizontal coordinate or x coordinate) may be an example of the radius value described in connection with one or more of FIGS. 1 and 5. For example, the Gain_{RNR} 770 values may be stored (in a LUT, for example) and may be determined (e.g., looked up) with the corresponding radius 772 values.

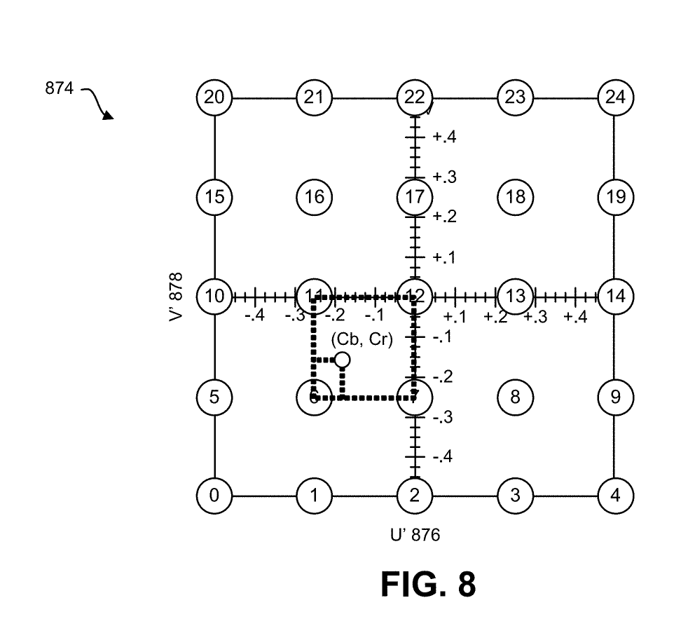

FIG. 8 is a graph 874 illustrating one example of a YUV color space. The graph 874 is illustrated in U′ 876 over V′ 878. A chrominance normalization gain may be defined relative to U′ and V′ as described in connection with FIG. 9.

FIG. 9 is a graph 980 illustrating one example of chrominance normalization gain (Gain_{CNR}) (e.g., an N×N gain map) that may be utilized in accordance with some configurations of the systems and methods disclosed herein. The graph 980 is illustrated in Gain_{CNR} 982 over U′ 976 and V′ 978. U′ (or U) may correspond to a blue luminance difference and V′ (or V) may correspond to a red luminance difference. For example, the x-coordinate may be U′ calculated by U′=Clamp(U, −127, 127), where Clamp is a clamping function. The y-coordinate may be V′ calculated by V′=Clamp(V, −127, 127), and the z-coordinate may be Gain_{CNR} 982. The chrominance normalization gain may be interpolated from an N×N gain map. The chrominance normalization gain may be utilized to normalize frequency band amplitudes (e.g., ACs) affected by white balance gains and/or other color processing blocks (e.g., a color correction matrix). For example, the chrominance normalization gain may enable tuning by chroma.

Smaller chrominance normalization gain may lead to smaller normalized ACs, which may result in greater suppression of ACs. An N×N gain map may be utilized to calculate Gain_{CNR} 982 for a block as shown in FIG. 9. In some configurations, the gain map may be tuned according to nonlinear color processing settings.

In some approaches, U′ 976 and V′ 978 described in connection with FIG. 9 may be an example of the coordinates described in connection with one or more of FIGS. 1 and 5. For example, the Gain_{CNR} 982 values may be stored (in a LUT, for example) and may be determined (e.g., looked up) with corresponding U′ 976 and V′ 978 values.

FIG. 10 is a block diagram illustrating an example of a skin color detector 1092 and a Gain_{SNR} calculator 1094. FIG. 10 also illustrates a Y averager 1086, a Cb averager 1088, and a Cr averager 1090. One or more of the elements (e.g., blocks) described in connection with FIG. 10 may be utilized for Gain_{SNR} calculation.

Y may denote a luma component, Cr may denote a red-difference chroma component, and Cb may denote a blue-difference chroma component. It should be noted that while the example given in FIG. 10 is described in terms of a YUV or YCbCr color space, other color spaces may be utilized.

The Y averager 1086, Cb averager 1088, and Cr averager 1090 may receive a set (e.g., block, sub-block, etc.) of image data (e.g., of an input image). For example, the Y averager 1086, Cb averager 1088, and Cr averager 1090 may receive 10 bits of YUV420 data. The Y averager 1086 may determine an 8×8 average of the Y component, the Cb averager 1088 may determine a 4×4 average of the Cb component, and the Cr averager 1090 may determine a 4×4 average of the Cr component, which may be provided to the skin color detector 1092. The averages may be spatial averages.

In some configurations, one or more of the functions described in connection with FIG. 10 may be performed for one or more sub-blocks for a whole block. For example, particular sub-block sizes (e.g., 8×8, 4×4, etc.) are given as examples in FIG. 10. The processing described in FIG. 10 may be performed for a set of sub-blocks corresponding to a whole block (where the whole block may be a subset of an image, for instance). Different whole block and/or sub-block sizes may be implemented.

The skin color detector 1092 may analyze a range (e.g., HSY or YUV domain value range) to determine a skin probability (sp) of a given pixel. The skin probability may indicate a probability of whether a pixel represents skin in an image. The skin probability may be provided to the Gain_{SNR} calculator 1094.

The Gain_{SNR} calculator 1094 may determine a skin color normalization gain (Gain_{SNR}) based on the skin probability. For example, the Gain_{SNR} calculator 1094 may determine (e.g., calculate, look up from a LUT, etc.) a Gain_{SNR} based on the skin probability. An example of the skin normalization gain (that may be determined from a skin probability 1198 on the horizontal axis) is given in connection with FIG. 11. In some configurations, one or more of the Y averager 1086, Cb averager 1088, Cr averager 1090, skin color detector 1092, or the Gain_{SNR} calculator 1094 may be included in a normalizer (e.g., normalizer 118, 518) and/or a normalization gain calculator 546. Skin regions may be de-noised more (than one or more other regions, for example) to provide the appearance of smoother skin.

FIG. 11 is a graph 1196 illustrating one example of skin color normalization gain (Gain_{SNR}) that may be utilized in accordance with some configurations of the systems and methods disclosed herein. The graph 1196 is illustrated in Gain_{SNR} 1101 over skin probability 1198 (sp). The Gain_{SNR} may be utilized to normalize frequency band amplitudes (e.g., ACs) to de-noise skin regions in a particular way. For example, the Gain_{SNR} may be utilized to de-noise skin regions more than other regions in an image. In some approaches, smaller skin color normalization gain may lead to smaller normalized ACs, which may result in greater suppression of ACs. A piecewise linear curve may be used to calculate Gain_{SNR} for a block as shown in FIG. 11, for example.

In some approaches, the skin probability 1198 described in connection with FIG. 11 (e.g., a horizontal coordinate or x coordinate) may be an example of the skin color probability described in connection with one or more of FIGS. 1, 5 and 10. For example, the Gain_{SNR} 1101 values may be stored (in a LUT, for example) and may be determined (e.g., looked up) with the corresponding skin probability 1198 values.

FIG. 12 is a graph 1203 illustrating one example of amplitude suppression gain (Gain_{NR}) (e.g., amplitude filtering gain) that may be utilized in accordance with some configurations of the systems and methods disclosed herein. The graph 1203 is illustrated in Gain_{NR} 1207 over normalized frequency band amplitude 1205 (AC_{Norm}). In some approaches, after amplitudes are normalized by the normalization gain (e.g., Gain_{LNR}, Gain_{RNR}, Gain_{CNR}, Gain_{SNR} combined normalization gain, and/or Gain_{Norm}, etc.), a unified filtering curve (e.g., unified amplitude suppression gain curve) may be utilized (e.g., set) to suppress ACs (e.g., 63 ACs) according to their normalized values. Smaller gain may lead to stronger suppression and/or noise reduction. The piecewise linear curve Gain_{NR} may be calculated for each AC as shown in FIG. 12, for example.

In some approaches, the normalized frequency band amplitude 1205 (AC_{Norm}) described in connection with FIG. 12 (e.g., a horizontal coordinate or x coordinate) may be an example of the AC_{Norm} value described in connection with one or more of FIGS. 1 and 5. For example, the Gain_{NR} 1207 values may be stored (in a LUT, for example) and may be determined (e.g., looked up) with the corresponding normalized frequency band amplitude 1205 (AC_{Norm}) values.

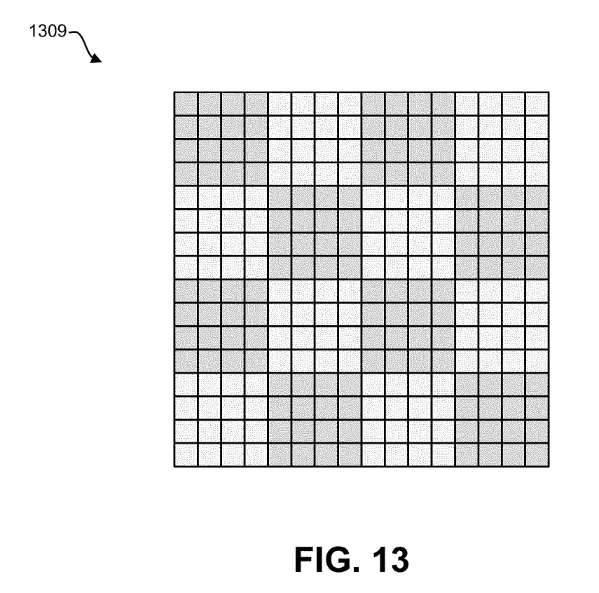

FIG. 13 is a diagram illustrating an example of a flatness filtering gain mask kernel (e.g., FNRₘₐₛₖ kernel, N×N FNR kernel, etc.) 1309 that may be utilized in some configurations of the systems and methods disclosed herein. For example, the flatness filtering gain mask kernel 1309 may be utilized to estimate flatness. For instance, flatness may be estimated by an N₁×N₂ kernel 1309 (e.g., 16×16). A sum of absolute differences of an N₁×N₂ block may be used to present FNRₘₐₛₖ, which may be calculated as described in connection with FIG. 14.

FIG. 14 is a graph 1411 illustrating one example of flatness filtering gain (Gain_{FNR}) that may be utilized in accordance with some configurations of the systems and methods disclosed herein. The graph 1411 is illustrated in Gain_{FNR} 1415 over flatness filtering gain mask (FNRₘₐₛₖ) 1413. In some configurations, the flatness filtering gain mask 1413 may be calculated in accordance with the following formula

$${FNR}_{mask} = \frac{{\sum }_{N \times N} ( {P}_{i , j} - mean )}{N \times N} ,$$

where mean is a block average and P_{i,j} represents each pixel value in a block. For example, mean may be a 16×16 block average in accordance with FIG. 13 and P_{i,j} may be each pixel value in the 16×16 block. The flatness filtering gain may be utilized to suppress frequency band amplitudes (e.g., 63 ACs) according to the flatness of the block (e.g., frequency band amplitudes corresponding to flatter blocks may be suppressed more). For example, smaller flatness filtering gain may lead to stronger suppression and/or noise reduction. A piecewise linear curve may be utilized to calculate Gain_{FNR} for each block as shown in FIG. 14.

In some approaches, the flatness value (FNRₘₐₛₖ) 1413 described in connection with FIG. 14 (e.g., a horizontal coordinate or x coordinate) may be an example of the flatness value described in connection with one or more of FIGS. 1 and 5. For example, the Gain_{FNR} 1415 values may be stored (in a LUT, for example) and may be determined (e.g., looked up) with the corresponding flatness filtering gain mask (FNRₘₐₛₖ) 1413.

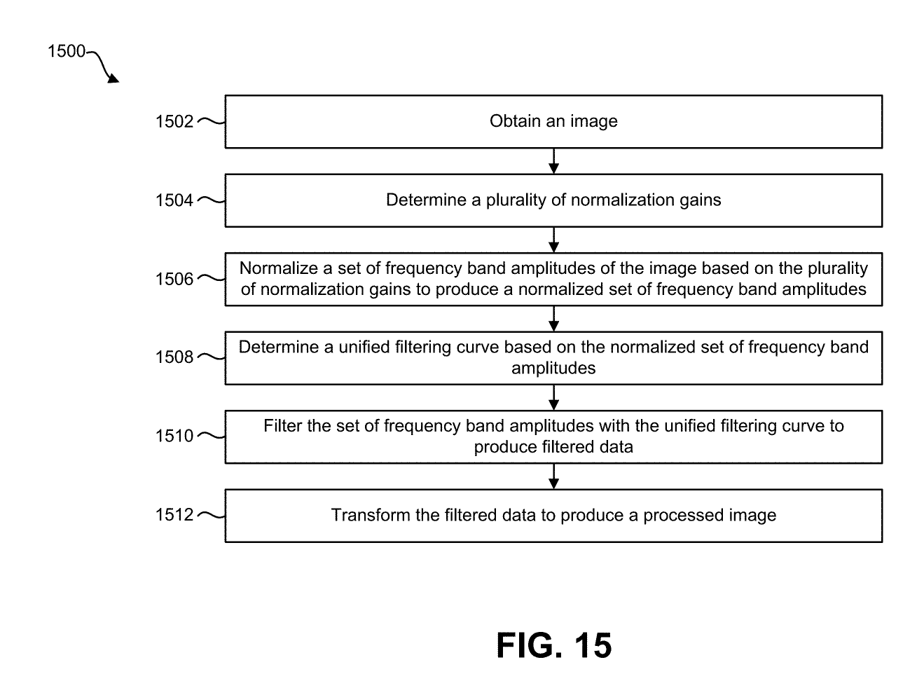

FIG. 15 is a flow diagram illustrating a more specific configuration of a method 1500 for image noise reduction. The method 1500 may be performed by an electronic device (e.g., the electronic device 102 described in connection with FIG. 1).

The electronic device 102 may obtain 1502 an image (e.g., input image). This may be accomplished as described in connection with one or more of FIGS. 1-2.

The electronic device 102 may determine 1504 a plurality of normalization gains. This may be accomplished as described in connection with one or more of FIGS. 1 and 5-14. For example, the electronic device 102 may look up each of the plurality of normalization gains from a respective look-up table with a respective value.

The electronic device 102 may normalize 1506 a set of frequency band amplitudes of the image based on the plurality of normalization gains to produce a normalized set of frequency band amplitudes. This may be accomplished as described in connection with one or more of FIGS. 1-2 and 5-14.

The electronic device 102 may determine 1508 a unified filtering curve based on the normalized set of frequency band amplitudes. This may be accomplished as described in connection with one or more of FIGS. 1 and 5. For example, the electronic device 102 may determine 1508 the unified filtering curve by looking up amplitude suppression gain values for each of the normalized set of frequency band amplitudes. In some configurations, the electronic device 102 may also determine a flatness filtering gain.

The electronic device 102 may filter 1510 the set of frequency band amplitudes with the unified filtering curve to produce filtered data. This may be accomplished as described in connection with one or more of FIGS. 1-3, 5, and 12.

The electronic device 102 may transform 1512 the filtered data to produce a processed image. This may be accomplished as described in connection with one or more of FIGS. 1-2 and 5.

In some configurations, the electronic device 102 may present the processed image on one or more displays (e.g., display(s) 124). Additionally or alternatively, the electronic device 102 may store the processed image in memory (e.g., memory 122). Additionally or alternatively, the electronic device 102 may send the processed image to one or more remote devices (with one or more communication interfaces 108, for example).

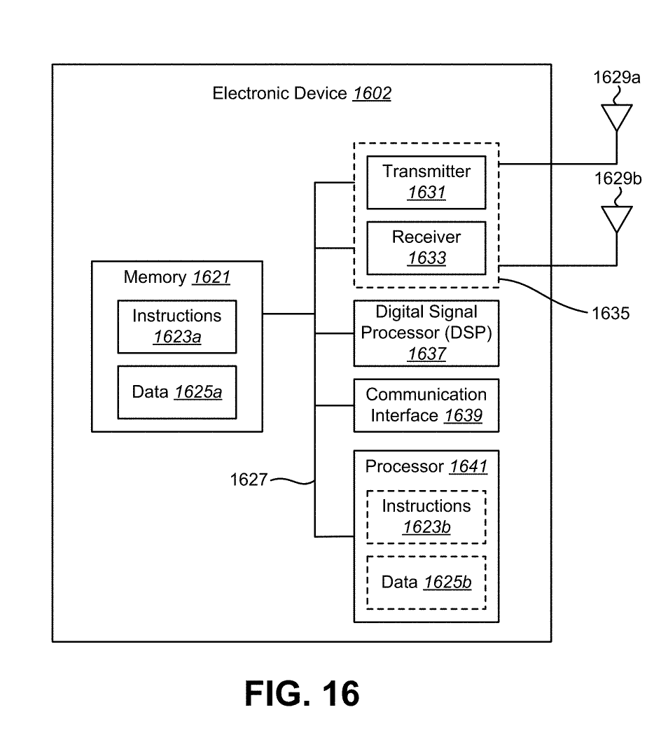

FIG. 16 illustrates certain components that may be included within an electronic device 1602 configured to implement various configurations of the systems and methods disclosed herein. For example, the electronic device 1602 may be implemented to perform image noise reduction based on a plurality of normalization gains in accordance with one or more configurations of the systems and methods disclosed herein. The electronic device 1602 may be and/or may be included in an access terminal, a mobile station, a user equipment (UE), a smartphone, a digital camera, a video camera, a tablet device, a laptop computer, a vehicle, a drone, an augmented reality device, a virtual reality device, an aircraft, an appliance, a television, etc. The electronic device 1602 may be implemented in accordance with one or more of the electronic devices and/or in accordance with one or more of the components and/or functions described herein (e.g., components and/or functions described in connection with one or more of FIGS. 1-15).

The electronic device 1602 includes a processor 1641. The processor 1641 may be a general purpose single- or multi-chip microprocessor (e.g., an ARM), a special purpose microprocessor (e.g., a digital signal processor (DSP), an image signal processor (ISP), etc.), a microcontroller, a programmable gate array, etc. The processor 1641 may be referred to as a central processing unit (CPU). Although just a single processor 1641 is shown in the electronic device 1602, in an alternative configuration, a combination of processors (e.g., an ARM and DSP) could be implemented.

The electronic device 1602 also includes memory 1621. The memory 1621 may be any electronic component capable of storing electronic information. The memory 1621 may be embodied as random access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM), registers, and so forth, including combinations thereof.

Data 1625a and instructions 1623a may be stored in the memory 1621. The instructions 1623a may be executable by the processor 1641 to implement one or more of the methods 200, 1500 described herein. Executing the instructions 1623a may involve the use of the data 1625a that is stored in the memory 1621. When the processor 1641 executes the instructions 1623, various portions of the instructions 1623b may be loaded onto the processor 1641, and various pieces of data 1625b may be loaded onto the processor 1641.

The electronic device 1602 may also include a transmitter 1631 and a receiver 1633 to allow transmission and reception of signals to and from the electronic device 1602. The transmitter 1631 and receiver 1633 may be collectively referred to as a transceiver 1635. One or more antennas 1629a-b may be electrically coupled to the transceiver 1635. The electronic device 1602 may also include (not shown) multiple transmitters, multiple receivers, multiple transceivers and/or additional antennas.

The electronic device 1602 may include a digital signal processor (DSP) 1637. The electronic device 1602 may also include a communication interface 1639. The communication interface 1639 may allow and/or enable one or more kinds of input and/or output. For example, the communication interface 1639 may include one or more ports and/or communication devices for linking other devices to the electronic device 1602. In some configurations, the communication interface 1639 may include the transmitter 1631, the receiver 1633, or both (e.g., the transceiver 1635). Additionally or alternatively, the communication interface 1639 may include one or more other interfaces (e.g., touchscreen, keypad, keyboard, microphone, camera, etc.). For example, the communication interface 1639 may enable a user to interact with the electronic device 1602.

The various components of the electronic device 1602 may be coupled together by one or more buses, which may include a power bus, a control signal bus, a status signal bus, a data bus, etc. For the sake of clarity, the various buses are illustrated in FIG. 16 as a bus system 1627.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing, and the like.

The phrase “based on” does not mean “based only on,” unless expressly specified otherwise. In other words, the phrase “based on” describes both “based only on” and “based at least on.”

The term “processor” should be interpreted broadly to encompass a general purpose processor, a central processing unit (CPU), a microprocessor, a digital signal processor (DSP), a controller, a microcontroller, a state machine, and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a DSP and a microprocessor, a plurality of microprocessors, one or more microprocessors in conjunction with a DSP core, or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), synchronous dynamic random access memory (SDRAM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

The functions described herein may be implemented in software or firmware being executed by hardware. The functions may be stored as one or more instructions on a computer-readable medium. The terms “computer-readable medium” or “computer-program product” refers to any tangible storage medium that can be accessed by a computer or a processor. By way of example, and not limitation, a computer-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk, and Blu-ray® disc where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed, or computed by the computing device or processor. As used herein, the term “code” may refer to software, instructions, code, or data that is/are executable by a computing device or processor.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio and microwave, then the coaxial cable, fiber optic cable, twisted pair, DSL, or wireless technologies such as infrared, radio and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

Further, it should be appreciated that modules and/or other appropriate means for performing the methods and techniques described herein, can be downloaded, and/or otherwise obtained by a device. For example, a device may be coupled to a server to facilitate the transfer of means for performing the methods described herein. Alternatively, various methods described herein can be provided via a storage means (e.g., random access memory (RAM), read-only memory (ROM), a physical storage medium such as a compact disc (CD) or floppy disk, etc.), such that a device may obtain the various methods upon coupling or providing the storage means to the device.

It is to be understood that the claims are not limited to the precise configuration and components illustrated above. Various modifications, changes, and variations may be made in the arrangement, operation, and details of the systems, methods, and apparatus described herein without departing from the scope of the claims.

What is claimed is:

1. A method performed by an electronic device, comprising:
obtaining an image;
normalizing a set of frequency band amplitudes of the image based on a plurality of normalization gains to produce a normalized set of frequency band amplitudes; and
producing a processed image based on the normalized set of frequency band amplitudes.

2. The method of claim 1, wherein the plurality of normalization gains comprise at least two of a radius normalization gain, a skin color normalization gain, a luminance normalization gain, and a chrominance normalization gain.

3. The method of claim 1, further comprising determining a unified filtering curve based on the plurality of normalization gains.

4. The method of claim 1, further comprising suppressing image noise based on the plurality of normalization gains, an amplitude suppression gain, and a flatness filtering gain.

5. The method of claim 1, further comprising performing a frequency domain transform on at least a portion of the image to produce the set of frequency band amplitudes.

6. The method of claim 1, wherein producing the processed image comprises performing an inverse frequency domain transform on amplitude filtered data.

7. The method of claim 1, further comprising:
performing skin color detection based on the set of frequency band amplitudes to determine a skin probability; and
determining a skin color normalization gain based on the skin probability, wherein the skin color normalization gain is one of the plurality of normalization gains.

8. An electronic device, comprising:
a normalizer configured to normalize a set of frequency band amplitudes of an image based on a plurality of normalization gains to produce a normalized set of frequency band amplitudes; and
a noise reducer configured to produce a processed image based on the normalized set of frequency band amplitudes.

9. The electronic device of claim 8, wherein the plurality of normalization gains comprise at least two of a radius normalization gain, a skin color normalization gain, a luminance normalization gain, and a chrominance normalization gain.

10. The electronic device of claim 8, wherein the normalizer is configured to determine a unified filtering curve based on the plurality of normalization gains.

11. The electronic device of claim 8, wherein the noise reducer is configured to suppress image noise based on the plurality of normalization gains, an amplitude suppression gain, and a flatness filtering gain.

12. The electronic device of claim 8, wherein the noise reducer is configured to perform a frequency domain transform on at least a portion of the image to produce the set of frequency band amplitudes.

13. The electronic device of claim 8, wherein the noise reducer is configured to produce the processed image by performing an inverse frequency domain transform on amplitude filtered data.

14. The electronic device of claim 8, wherein the normalizer is configured to perform skin color detection based on the set of frequency band amplitudes to determine a skin probability; and to determine a skin color normalization gain based on the skin probability, wherein the skin color normalization gain is one of the plurality of normalization gains.

15. A computer-program product, comprising a non-transitory computer-readable medium having instructions thereon, the instructions comprising:
code for causing an electronic device to obtain an image;
code for causing the electronic device to normalize a set of frequency band amplitudes of the image based on a plurality of normalization gains to produce a normalized set of frequency band amplitudes; and
code for causing the electronic device to produce a processed image based on the normalized set of frequency band amplitudes.

16. The computer-program product of claim 15, wherein the plurality of normalization gains comprise at least two of a radius normalization gain, a skin color normalization gain, a luminance normalization gain, and a chrominance normalization gain.

17. The computer-program product of claim 15, the instructions further comprising code for causing the electronic device to determine a unified filtering curve based on the plurality of normalization gains.

18. The computer-program product of claim 15, the instructions further comprising code for causing the electronic device to suppress image noise based on the plurality of normalization gains, an amplitude suppression gain, and a flatness filtering gain.

19. The computer-program product of claim 15, wherein the code for causing the electronic device to produce the processed image comprises code for causing the electronic device to perform an inverse frequency domain transform on amplitude filtered data.

20. The computer-program product of claim 15, the instructions further comprising:
code for causing the electronic device to perform skin color detection based on the set of frequency band amplitudes to determine a skin probability; and
code for causing the electronic device to determine a skin color normalization gain based on the skin probability, wherein the skin color normalization gain is one of the plurality of normalization gains.
